(19) United States
(12) Patent Application Publication
(10) Pub. No.: US 2026/0206080 A1
(43) Pub. Date: Jul. 16, 2026

(54) COMMUNICATION METHOD AND SYSTEM, WIRELESS ACCESS DEVICE AND ACCESS CONTROLLER

(71) Applicant: CLOUD INTELLIGENCE ASSETS HOLDING (SINGAPORE) PRIVATE LIMITED, Singapore (SG)

(72) Inventors: Jianzhi GUAN, Hangzhou, Zhejiang (CN); Yun MEI, Hangzhou, Zhejiang (CN); Quan YANG, Hangzhou, Zhejiang (CN); Lei SHI, Beijing (CN); Kai MA, Guangzhou, Guangdong (CN); Yidong YAO, Hangzhou, Zhejiang (CN)

(21) Appl. No.: 18/867,772

(22) PCT Filed: May 22, 2023
(86) PCT No.: PCT/CN2023/095620

§ 371 Date: Nov. 20, 2024

(30) Foreign Application Priority Data
May 23, 2022 (CN) 202210567200.X

(51) Int. Cl. H04W 76/15; H04L 61/5007; H04L 101/622; H04W 36/08

(52) U.S. Cl. CPC H04W 76/15; H04L 61/5007; H04W 36/08; H04L 2101/622

(57) ABSTRACT

A communication method and system, a wireless access device and an access controller are provided. The system includes: a first terminal, a second terminal, a plurality of wireless access devices, and a core network device. The first wireless access device acquires a first IP address allocated for the first terminal by the core network device; and sends first notification information including a second IP address of the first wireless access device and the first IP address to the core network device. The core network device generates first forwarding information according to the first notification information that is used for an indication of sending, to the first wireless access device, a data message for which a destination IP address is the first IP address; receives the data message, sent by the second terminal; and sends the data message to the first wireless access device according to the first forwarding information.

### CROSS-REFERENCE TO RELATED APPLICATIONS

The present application is a National Stage of International Application No. PCT/CN2023/095620, filed on May 22, 2023, which claims priority to Chinese Patent Application No. 202210567200.X, filed on May 23, 2022 to the China National Intellectual Property Administration and entitled “COMMUNICATION METHOD AND SYSTEM, WIRELESS ACCESS DEVICE AND ACCESS CONTROLLER”. These applications are incorporated into the present application by reference in their entireties.

### TECHNICAL FIELD

The present invention relates to the field of Internet technology and, in particular, to a communication method and system, a wireless access device and an access controller.

### BACKGROUND

In daily work and life, a wireless local area network has become a widely used networking manner. In the wireless local area network, there is a network access device deployed: a wireless access point (abbreviated as AP). A user terminal achieves network connection by accessing the AP.

In a practical application, such as in enterprise environments, multiple APs may be deployed within a wireless local area network. When a user terminal accesses a certain AP1 among them, the AP1 allocates an IP address for the user terminal, and the user terminal uses the IP address for data communication. When the user terminal roams from the AP1 to another AP2, the AP2 allocates a new IP address for the user terminal, and the user terminal uses the new IP address for communication and transmission. The change of the IP address can cause interruption of data communication services in progress on the user terminal, affecting the user experience.

### SUMMARY

Embodiments of the present invention provide a communication method and system, a wireless access device and a core network device, for seamless switching of a terminal among different wireless access devices.

In a first aspect, an embodiment of the present invention provides a communication system, including:
a first terminal, a second terminal, a plurality of wireless access devices, and a core network device connected in communication with the plurality of wireless access devices;
where a first wireless access device in the plurality of wireless access devices is configured to: acquire, after being connected with the first terminal, a first IP address allocated for the first terminal by the core network device; and send first notification information to the core network device, where the first notification information includes a second IP address of the first wireless access device and the first IP address;
the core network device is configured to: generate first forwarding information according to the first notification information, where the first forwarding information is used for an indication of sending, to the first wireless access device corresponding to the second IP address, a data message for which a destination IP address is the first IP address; and, if upon reception of the data message, sent by the second terminal, for which the destination IP address is the first IP address, send the data message to the first wireless access device according to the first forwarding information, to enable the first wireless access device to send the data message to the first terminal.

In a second aspect, an embodiment of the present invention provides a communication method, applied to any target wireless access device in a plurality of wireless access devices contained within a communication system, where the communication system includes: a first terminal, a second terminal, the plurality of wireless access devices, and a core network device connected in communication with the plurality of wireless access devices; the method includes:
acquiring, after being connected with the first terminal, a first IP address allocated for the first terminal by the core network device;
sending first notification information including a second IP address of the target wireless access device and the first IP address to the core network device, to enable the core network device to generate forwarding information according to the first notification information, where the forwarding information is used for an indication of sending, to the target wireless access device corresponding to the second IP address, a data message for which a destination IP address is the first IP address;
receiving the data message, forwarded by the core network device, for which the destination IP address is the first IP address, where the core network device sends the data message to the target wireless access device according to the forwarding information when the data message sent by the second terminal is received; and
sending the data message to the first terminal.

In a third aspect, an embodiment of the present invention provides a communication method, applied to a core network device contained within a communication system, where the communication system includes: a first terminal, a second terminal, a plurality of wireless access devices, and the core network device connected in communication with the plurality of wireless access devices; the method includes:
receiving an address acquiring request sent by a first wireless access device in the plurality of wireless access devices, where the address acquiring request is sent to the first wireless access device after the first terminal is connected with the first wireless access device;
sending a first IP address allocated for the first terminal to the first wireless access device, to enable the first wireless access device to send the first IP address to the first terminal;
receiving first notification information sent by the first wireless access device, where the first notification information includes the first IP address of the first terminal and a second IP address of the first wireless access device;
generating first forwarding information according to the first notification information, where the first forwarding information is used for an indication of sending, to the first wireless access device corresponding to the second IP address, a data message for which a destination IP address is the first IP address; and
if upon reception of the data message, sent by the second terminal, for which the destination IP address is the first IP address, sending the data message to the first wireless access device according to the first forwarding information, to enable the first wireless access device to send the data message to the first terminal.

In a fourth aspect, an embodiment of the present invention provides a communication apparatus, arranged in any target wireless access device in a plurality of wireless access devices contained within a communication system, where the communication system includes: a first terminal, a second terminal, the plurality of wireless access devices, and a core network device connected in communication with the plurality of wireless access devices; the apparatus includes:
an acquisition module, configured to acquire, after being connected with the first terminal, a first IP address allocated for the first terminal by the core network device;
a transmitting module, configured to send first notification information including a second IP address of the target wireless access device and the first IP address to the core network device, to enable the core network device to generate forwarding information according to the first notification information, where the forwarding information is used for an indication of sending, to the target wireless access device corresponding to the second IP address, a data message for which a destination IP address is the first IP address; and
a reception module, configured to receive the data message, forwarded by the core network device, for which the destination IP address is the first IP address, where the core network device sends the data message to the target wireless access device according to the forwarding information when the data message sent by the second terminal is received;
where the transmitting module is further configured to send the data message to the first terminal.

In a fifth aspect, an embodiment of the present invention provides a communication apparatus, arranged in a core network device contained within a communication system, where the communication system includes: a first terminal, a second terminal, a plurality of wireless access devices, and the core network device connected in communication with the plurality of wireless access devices; the apparatus includes:
a reception module, configured to receive an address acquiring request sent by a first wireless access device in the plurality of wireless access devices, where the address acquiring request is sent to the first wireless access device after the first terminal is connected with the first wireless access device;
a transmitting module, configured to send a first IP address allocated for the first terminal to the first wireless access device, to enable the first wireless access device to send the first IP address to the first terminal;
where the reception module is further configured to receive first notification information sent by the first wireless access device, where the first notification information includes the first IP address of the first terminal and a second IP address of the first wireless access device; and
a generation module, configured to generate first forwarding information according to the first notification information, where the first forwarding information is used for an indication of sending, to the first wireless access device corresponding to the second IP address, a data message for which a destination IP address is the first IP address;
   where the transmitting module is further configured to: if upon reception of the data message, sent by the second terminal, for which the destination IP address is the first IP address, send the data message to the first wireless access device according to the first forwarding information, to enable the first wireless access device to send the data message to the first terminal.

In a sixth aspect, an embodiment of the present invention provides a wireless access device, including: a memory, a processor, and a communication interface; where the memory stores executable codes thereon, and when the executable codes are executed by the processor, the processor is enabled to perform the communication method as described in the second aspect.

In a seventh aspect, an embodiment of the present invention provides a core network device, including: a memory, a processor, and a communication interface; where the memory stores executable codes thereon, and when the executable codes are executed by the processor, the processor is enabled to perform the communication method as described in to the third aspect.

In an eighth aspect, an embodiment of the present invention provides a communication system, including:
a first terminal, a second terminal, a plurality of wireless access devices, a forwarding subsystem and an address allocation server; where the plurality of wireless access devices and the address allocation server are respectively connected in communication with the forwarding subsystem, the forwarding subsystem includes a core network device;
the first terminal is configured to send, after being connected with a first wireless access device in the plurality of wireless access devices, an address acquiring request to the first wireless access device;
the first wireless access device is configured to forward, through the core network device, the address acquiring request to the address allocation server, and receive a first IP address allocated for the first terminal by the address allocation server, and send first notification information to the forwarding subsystem; where the first notification information includes a second IP address of the first wireless access device and the first IP address;
the forwarding subsystem is configured to: generate first forwarding information according to the first notification information; and store the first forwarding information in the core network device, where the first forwarding information is used for an indication of sending, to the first wireless access device corresponding to the second IP address, a data message for which a destination IP address is the first IP address;
the core network device is configured to: store the first forwarding information; and if upon reception of the data message, sent by the second terminal, for which the destination IP address is the first IP address, send the data message to the first wireless access device according to the first forwarding information, to enable the first wireless access device to send the data message to the first terminal.

In a ninth aspect, an embodiment of the present invention provides a vehicle-to-everything communication system, including:
an onboard terminal, a control terminal, a plurality of wireless access devices, and a core network device connected in communication with the plurality of wireless access devices;
where a first wireless access device in the plurality of wireless access devices is configured to: acquire, after being connected with the onboard terminal, a first IP address allocated for the onboard terminal by the core network device; and send first notification information to the core network device, where the first notification information includes a second IP address of the first wireless access device and the first IP address;
the core network device is configured to: generate first forwarding information according to the first notification information, where the first forwarding information is used for an indication of sending, to the first wireless access device corresponding to the second IP address, a data message for which a destination IP address is the first IP address; and, if upon reception of the data message, sent by the control terminal, for which the destination IP address is the first IP address, send the data message to the first wireless access device according to the first forwarding information, to enable the first wireless access device to send the data message to the onboard terminal.

A solution according to an embodiment of the present invention provides a communication system, which includes a first terminal, a second terminal, a plurality of wireless access devices, and a core network device connected in communication with the plurality of wireless access devices.

Specifically, after the first terminal accesses a certain wireless access device (assuming it is a first wireless access device), the first wireless access device will acquire a first IP address allocated for the first terminal by the core network device. Since the first IP address of the first terminal is allocated by the core network device, the wireless access device does not provide a function of allocating IP addresses. Therefore, the first IP address can remain unchanged when the first terminal roams among different wireless access devices, so that the services for communication and transmission in progress on the first terminal will not experience service interruptions due to IP address changes caused by the first terminal roaming among different wireless access devices. In addition, after acquiring a first notification information including a second IP address of the first wireless access device and the first IP address, the core network device learns that the first terminal has accessed the first wireless access device currently, then generates, according to the first notification information, first forwarding information which is used for an indication of sending, to the first wireless access device corresponding to the second IP address, a data message for which a destination IP address is the first IP address. Based on this, if the core network device subsequently receives the data message, sent by the second terminal, for which the destination IP address is the first IP address, the core network device can hit the above-mentioned first forwarding information by querying a forwarding information list, in order to send, based on the first forwarding information, the data packet to the first terminal finally through the first wireless access device. In this way, communication between the second terminal and the first terminal is achieved through a forwarding function provided by the core network device.

### BRIEF DESCRIPTION OF DRAWINGS

In order to illustrate the technical solutions of embodiments of the present invention more clearly, the drawings that need to be used in the description of the embodiments will be briefly introduced in the following. Obviously, the drawings in the following description are intended for some embodiments of the present invention. For those of ordinary skill in the art, other drawings can be obtained according to these drawings without paying any creative effort.

FIG. 1 is a schematic diagram of a communication system provided by an embodiment of the present invention.

FIG. 2 is a schematic interaction flowchart of a communication method provided by an embodiment of the present invention.

FIG. 3 is a schematic interaction flowchart of a communication method provided by an embodiment of the present invention.

FIG. 4 is a schematic diagram of a communication system provided by an embodiment of the present invention.

FIG. 5 is a schematic interaction flowchart of a communication method provided by an embodiment of the present invention.

FIG. 6 is a schematic interaction flowchart of a communication method provided by an embodiment of the present invention.

FIG. 7 is a schematic diagram of a communication system provided by an embodiment of the present invention.

FIG. 8 is a schematic interaction flowchart of a communication method provided by an embodiment of the present invention.

FIG. 9 is a schematic interaction flowchart of a communication method provided by an embodiment of the present invention.

FIG. 10 is a schematic diagram of a vehicle-to-everything communication system provided by an embodiment of the present invention.

FIG. 11 is a schematic application diagram of a communication method provided by an embodiment of the present invention.

FIG. 12 is a schematic application diagram of a communication method provided by an embodiment of the present invention.

FIG. 13 is a schematic structure diagram of a communication apparatus provided by an embodiment of the present invention.

FIG. 14 is a schematic structure diagram of a wireless access device provided by an embodiment of the present invention.

FIG. 15 is a schematic structure diagram of a communication apparatus provided by an embodiment of the present invention.

FIG. 16 is a schematic structure diagram of a core network device provided by an embodiment of the present invention.

### DESCRIPTION OF EMBODIMENTS

In order to make the purpose, technical solution, and advantages of the embodiments of the present invention clearer, the following will provide a clear and comprehensive description of the technical solution in the embodiments of the present invention in conjunction with the accompanying drawings of the embodiments of the present invention. Obviously, the described embodiments are a part of the embodiments of the present invention, not all of them. Based on the embodiments of the present invention, all other embodiments obtained by those of ordinary skill in the art without any creative effort are within the protection scope of the present invention.

In the below, some embodiments of the present invention will be described in detail in conjunction with the drawings. In the absence of conflicts between the embodiments, the following embodiments and features in the embodiments can be combined with each other.

In addition, the timing sequence of steps in the following method embodiments is only an example and not a strict limitation.

FIG. 1 is a schematic diagram of a communication system provided by an embodiment of the present invention. As shown in FIG. 1, the communication system includes multiple terminals (only a first terminal and a second terminal are shown in the drawing), a plurality of wireless access devices (assuming there are N wireless access devices), and a core network device connected in communication with the plurality of wireless access devices.

The wireless access devices are connected in communication with the core network device. Specifically, in a practical application, the plurality of wireless access devices can be connected with the core network device through different base stations (not shown in the drawing).

A terminal can establish communication connections with different wireless access devices as its location shifts. For example, the first terminal establishes a communication connection with a first wireless access device within network coverage of the first wireless access device. When the first terminal moves into network coverage of a second wireless access device, the first terminal can disconnect the communication connection with the first wireless access device and establish a communication connection with the second wireless access device. In addition, it should be noted that a terminal can also establish a communication connection directly with the core network device through a base station.

A wireless access device can be a customer premise equipment (Customer Premise Equipment, abbreviated as CPE) that can achieve mutual conversion between different signals, such as a 5G CPE that can achieve mutual conversion between mobile cellular network signals and wireless LAN signals. In an embodiment of the present invention, the wireless access device integrates the function of a signal access point therein, so that the terminal can access the wireless access device. Still taking the wireless access device being the 5G CPE as an example, the 5G CPE can integrate AP function therein, and the terminal can access the 5G CPE based on the AP function of the 5G CPE to achieve network connection and communication.

For ease of understanding, the following takes the wireless access device being able to achieve mutual conversion between a first network signal and a second network signal as an example. That is, in this embodiment, it can be understood as that each wireless access device is actually provided with two communication chips, respectively corresponding to a first network and a second network. The first terminal is connected in communication with a wireless access device through the first network signal, the second terminal is connected in communication with the core network device through the second network signal, and each wireless access device is connected in communication with the core network device through the second network signal.

In the communication system provided in the embodiment of the present invention, some constituent units therein can be configured in advance, among them, mainly respective wireless access devices are required to be configured.

In an implementation, firstly, in the same first network, respective wireless access devices may be indistinguishable for respective terminal devices according to actual needs. In this case, the respective wireless access devices can be configured to have a same network name, that is, the service set identifier (abbreviated as SSID). Secondly, in this first network, all wireless access devices can serve as the same gateway for the first terminal, so IP (Internet protocol) addresses of respective wireless access devices in the first network can be configured to be the same, so that the terminal does not perceive changes when roaming into a range of a different wireless access device. The SSIDs of a plurality of wireless access devices being the same and the IP addresses in the first network being the same as described above are only configurations in an example, and they can also be configured to be different from each other.

In addition, as mentioned above, the wireless access devices have a communication function between the first network and the second network. In the second network, for the core network device, each wireless access device is a different communication entity. Therefore, in the second network, each wireless access device has a different IP address, such as 40.1.0.1, 40.1.0.2, . . . , 40.1.0.N illustrated in FIG. 1.

Based on the communication system shown in FIG. 1, assuming that the first terminal is currently connected to the first wireless access device, at this time, in order to meet requirements for communication between the first terminal and the second terminal, the working process of respective constituent units in the communication system can be summarized as follows.

The first wireless access device is configured to: acquire, after being connected with the first terminal, a first IP address allocated by the core network device for the first terminal; and send first notification information to the core network device, where the first notification information includes a second IP address of the first wireless access device and the first IP address.

The core network device is configured to: generate first forwarding information according to the first notification information, where the first forwarding information is used for an indication of sending, to the first wireless access device corresponding to the second IP address, a data message for which a destination IP address is the first IP address; and, if upon reception of the data message, sent by the second terminal, for which the destination IP address is the first IP address, send the data message to the first wireless access device according to the first forwarding information, to enable the first wireless access device to send the data message to the first terminal.

In a practical application, in an implementation, the core network device can be a server including multiple functional modules therein; in an implementation, the above-mentioned multiple functional modules include a core network element, an IP address allocation element, and a wireless controller element configured to control the plurality of wireless access devices. Among them, the core network element can be any type of element in the 5G core network system that can achieve information forwarding function.

In this embodiment, when assuming that the core network element, the IP address allocation element, and the wireless controller element are integrated into the same core network device, the IP address allocation element and the wireless controller element can be respectively connected in communication with the core network element, and the above-mentioned plurality of wireless access devices are connected in communication with the core network element. In a practical application, specifically, the above-mentioned plurality of wireless access devices can be connected in communication with the core network element through different base stations.

For ease of understanding the working process of the above-mentioned respective constituent units, detailed explanation is made in conjunction with following embodiments in the below.

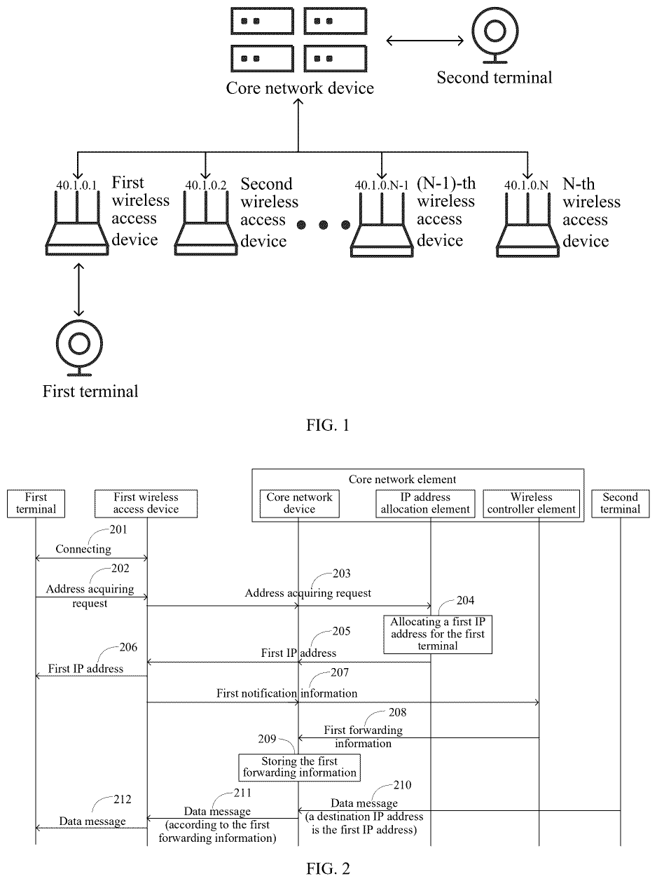

FIG. 2 is a schematic interaction flowchart of a communication method provided by an embodiment of the present invention. As shown in FIG. 2, the method includes following steps.
201, the first terminal is connected to the first wireless access device.
202, the first terminal sends an address acquiring request to the first wireless access device.

In this embodiment, it is assumed that the first terminal is first associated with the first wireless access device, that is, a communication connection is established with the first wireless access device.

During a process of establishing a communication connection with the first wireless access device, the first wireless access device will obtain a media access control (abbreviated as MAC) address of the first terminal.

After the first terminal establishes the communication connection with the first wireless access device, if the first terminal finds that it does not have an IP address of the first network or a previously allocated IP address has expired, the first terminal will send, to the first wireless access device, the address acquiring request for requesting an IP address. Among them, as mentioned above, the first network refers to a communication network between the first terminal and the wireless access devices.
203, the first wireless access device forwards the address acquiring request to the IP address allocation element in the core network device.

A respective wireless access device is configured with a relay forwarding function for the address acquiring request, this function enables the wireless access device to forward the received address acquiring request finally to the IP address allocation element in the core network device.
204, the IP address allocation element in the core network device allocates the first IP address for the first terminal.
205, the IP address allocation element in the core network device sends the first IP address to the first wireless access device through the core network element.
206, the first wireless access device sends the first IP address to the first terminal.
207, the first wireless access device sends first notification information including a second IP address of the first wireless access device and the first IP address to the wireless controller element in the core network device.

After receiving the first IP address allocated for the first terminal by the IP address allocation element, the first wireless access device, on the one hand, sends the first IP address to the first terminal, so that the first terminal is configured to subsequently use the first IP address for data transmission; and on the other hand, sends the first IP address of the first terminal and the second IP address of its own corresponding to the second network to the wireless controller element of the core network device. Among them, as mentioned above, the second network refers to a communication network between the wireless access device and the core network device.

In fact, the above-mentioned first notification information may further include a MAC address of the first terminal.

In an embodiment of the present invention, all the IP addresses of the first terminal are uniformly allocated by the IP address allocation element, and if the validity period of the IP address is not considered, it can be assumed that the IP address (referring to an IP address used for communication within the first network and allocated by the IP address allocation element) of the same terminal remains unchanged when the terminal accesses different wireless access devices.
208, the wireless controller element in the core network device sends, to the core network element, first forwarding information which is used for an indication of sending, to the first wireless access device, a data message for which a destination IP address is the first IP address.
209, the core network element in the core network device stores the first forwarding information.

After receiving the above-mentioned first notification information, the wireless controller element learns that the first terminal has accessed a first wireless access device currently, and then issues a forwarding rule to the core network deice, that is, the first forwarding information which is used for an indication of sending, to the first wireless access device, a data message for which a destination IP address is the first IP address.
210, the core network element in the core network device receives the data message, sent by the second terminal, for which the destination IP address is the first IP address.
211, the core network element in the core network device sends the data message to the first wireless access device according to the first forwarding information.

The second terminal is connected in communication with the core network element of the core network device through the second network. In a practical application, when the second terminal needs to send the data message to the first terminal, the data message will carry the first IP address of the first terminal therein, the data message is firstly sent to the core network element; after receiving the data message, the core network element needs to query in a local forwarding table for forwarding information matched for the data message. The forwarding table stores several pieces of forwarding information. The core network element queries in the forwarding table based on the destination IP address (i.e., the first IP address) in the data message; and if the first forwarding information for which the destination IP address is the first IP address is queried, sends, according to description in the first forwarding information, the data message to the first wireless access device corresponding to the second IP address.
212, the first wireless access device sends the data message to the first terminal.

In summary, in the solution provided by this embodiment, all IP addresses of terminals (i.e., the first terminal) connected to the wireless access device are uniformly allocated by the IP address allocation element of the core network device, so that an IP address of a terminal remains unchanged when the terminal roams among different wireless access devices, thus the services for communication and transmission in progress on the terminal will not experience service interruptions due to IP address changes caused by roaming among different wireless access devices.

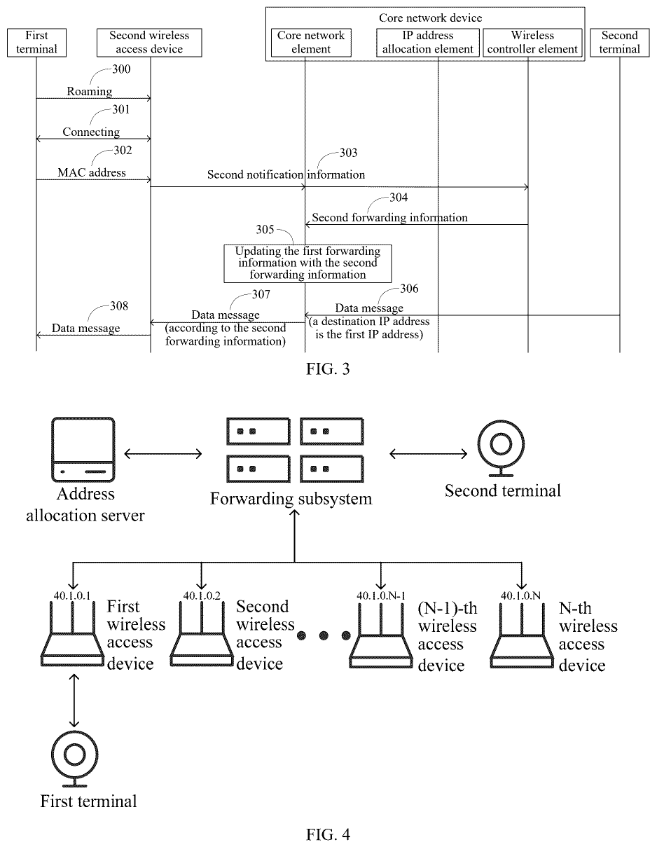

In a practical application, the first terminal may experience a shift in location, it may roam from the first wireless access device to which the first terminal is originally connected to coverage of the second wireless access as its location shifts. Assuming that the first terminal roams to the coverage of the second wireless access, at this time, a communication process of the first terminal can be completed in conjunction with an embodiment shown in FIG. 3.

FIG. 3 is a schematic interaction flowchart of a communication method provided by an embodiment of the present invention. As shown in FIG. 3, the method includes following steps.
300, the first terminal roams from the first wireless access device to the second wireless access device.
301, the first terminal is connected to the second wireless access device.
302, the second wireless access device acquires the MAC address of the first terminal.

During a process of establishing a communication connection with the second wireless access device, the second wireless access device will acquire the MAC address of the first terminal.
303, the second wireless access device sends second notification information including the MAC address of the first terminal and a third IP address of the second wireless access device to the wireless controller element in the core network device.

The third IP address is an IP address of the second wireless access device corresponding to the second network. As mentioned above, the second network refers to the communication network between the wireless access device and the core network device.
304, the wireless controller element in the core network device sends, to the core network element in the core network device, second forwarding information which is used for an indication of sending, to the second wireless access device, a data message for which a destination IP address is the first IP address.

As described in aforementioned embodiments, the MAC address of the first terminal is included in the first notification information received by the wireless controller element, in this way, the wireless controller element can locally store a corresponding relationship between the MAC address of the first terminal and the first IP address. Based on the corresponding relationship, when the wireless controller element receives the above-mentioned second notification information, the wireless controller element can determine, according to the MAC address of the first terminal, the first IP address of the first terminal. The second notification information is sent by the second wireless access device, which means that the first terminal has accessed the second wireless access device currently, therefore, the wireless controller element issues a new forwarding rule to the core network device: an indication of sending, to the second wireless access device, the data message for which the destination IP address is the first IP address.
305, the core network element in the core network device updates the first forwarding information with the second forwarding information.
306, the core network element in the core network device receives the data message, sent by the second terminal, for which the destination IP address is the first IP address.
307, the core network element in the core network device sends, according to the second forwarding information, the data message to the second wireless access device.
308, the second wireless access device sends the data message to the first terminal.

It can be known, from the above-mentioned solution, that when the first terminal roams among different wireless access devices, its IP address will not change, and thus services will not be interrupted. Moreover, based on the roaming situation of the first terminal among different wireless access devices, a corresponding forwarding rule in the core network device can be updated in real time, with simple implementations and low costs.

FIG. 4 is a schematic diagram of a communication system provided by an embodiment of the present invention. As shown in FIG. 4, it is assumed that the communication system includes multiple terminals (only a first terminal and a second terminal are shown in the drawing), a plurality of wireless access devices (assuming there are N wireless access devices illustrated in the drawing), a forwarding subsystem and an address allocation server.

The wireless access devices and the address allocation server are respectively connected in communication with the forwarding subsystem; in this embodiment, the forwarding subsystem may include a core network device. The connection relationship between the terminals and the wireless access devices as well as configuration information of the wireless access device, etc., are the same as the aforementioned embodiments, which will not be repeated here.

In this embodiment, it is assumed that a function of allocating IP addresses of a terminal is implemented by an address allocation server which is physically independent from the core network device. In other words, unlike the aforementioned embodiments, the core network device in this embodiment is no longer integrated with an IP address allocation element.

Based on the communication system shown in FIG. 4, assuming that the first terminal is currently connected to the first wireless access device, at this time, in order to meet requirements for communication between the first terminal and the second terminal, the working process of respective constituent units in the communication system can be summarized as follows.

The first terminal is configured to send, after being connected with the first wireless access device in the plurality of wireless access devices, an address acquiring request to the first wireless access device.

The first wireless access device is configured to forward, through the core network device, the address acquiring request to the address allocation server, and receive a first IP address allocated for the first terminal by the address allocation server, and send first notification information to the forwarding subsystem; where the first notification information includes a second IP address of the first wireless access device and the first IP address.

The forwarding subsystem is configured to: generate first forwarding information according to the first notification information and store the first forwarding information in the core network device, where the first forwarding information is used for an indication of sending, to the first wireless access device corresponding to the second IP address, a data message for which a destination IP address is the first IP address. Specifically, an access controller is configured to send the first forwarding information to the core network device according to the first notification information. The core network device is configured to store the first forwarding information; and if upon reception of the data message, sent by the second terminal, for which the destination IP address is the first IP address, send the data message to the first wireless access device according to the first forwarding information, to enable the first wireless access device to send the data message to the first terminal.

In a practical application, in an implementation, the forwarding subsystem may further include the access controller for controlling the plurality of wireless access devices, correspondingly, the access control is connected in communication with the core network device. In other words, in an implementation, the access controller can be physically deployed independent from the core network device; of course, in another implementation, the access controller can also be integrated into the core network device as an access controller element. In this embodiment, the case of independent deployment is taken as an example to illustrate.

For ease of understanding the working process of the above-mentioned respective constituent units, detailed explanation is made in conjunction with following embodiments in the below.

FIG. 5 is a schematic interaction flowchart of a communication method provided by an embodiment of the present invention. As shown in FIG. 5, the method includes following steps.
501, the first terminal is connected to the first wireless access device.
502, the first terminal sends an address acquiring request to the first wireless access device.

Like the aforementioned embodiments, during a process of establishing a communication connection with the first terminal, the first wireless access device will also acquire the MAC address of the first terminal.
503, the first wireless access device forwards the address acquiring request to the address allocation server.
504, the address allocation server allocates the first IP address for the first terminal.
505, the address allocation server sends the first IP address to the first wireless access device.
506, the first wireless access device sends the first IP address to the first terminal.
507, the first wireless access device sends first notification information including a second IP address of the first wireless access device and the first IP address to the access controller in the forwarding subsystem.

Like the aforementioned embodiments, after receiving the first IP address allocated for the first terminal by the address allocation server, the first wireless access device, on the one hand, sends the first IP address to the first terminal, so that the first terminal is configured to subsequently use the first IP address for data transmission; and on the other hand, sends the first IP address of the first terminal and the second IP address of its own corresponding to the second network to the access controller in the forwarding subsystem. Among them, as mentioned above, the second network refers to a communication network between the wireless access device and the core network device.

As described in the aforementioned embodiments, the MAC address of the first terminal may also be included in the above-mentioned first notification information.
508, the access controller in the forwarding subsystem sends, to the core network device, first forwarding information which is used for an indication of sending, to the first wireless access device, a data message for which a destination IP address is the first IP address.
509, the core network device stores the first forwarding information.

. After receiving the above-mentioned first notification information, the access controller in the forwarding subsystem learns that the first terminal has accessed the first wireless access device currently, and then issues a forwarding rule to the core network deice, that is, the first forwarding information which is used for an indication of sending, to the first wireless access device, a data message for which a destination IP address is the first IP address.
510, the core network device receives the data message, sent by the second terminal, for which the destination IP address is the first IP address.
511, the core network device sends the data message to the first wireless access device according to the first forwarding information.

In a practical application, the second terminal can be connected in communication with the core network device through a base station, when the second terminal needs to send the data message to the first terminal, the data message will carry the first IP address of the first terminal therein, the data message is firstly sent to the core network device; after receiving the data message, the core network device needs to query in a local forwarding table for forwarding information matched for the data message. The forwarding table stores several pieces of forwarding information therein. The core network device queries in the forwarding table based on the destination IP address (i.e., the first IP address) in the data message; and if the first forwarding information for which the destination IP address is the first IP address is queried, sends, according to description in the first forwarding information, the data message to the first wireless access device corresponding to the second IP address.
512, the first wireless access device sends the data message to the first terminal.

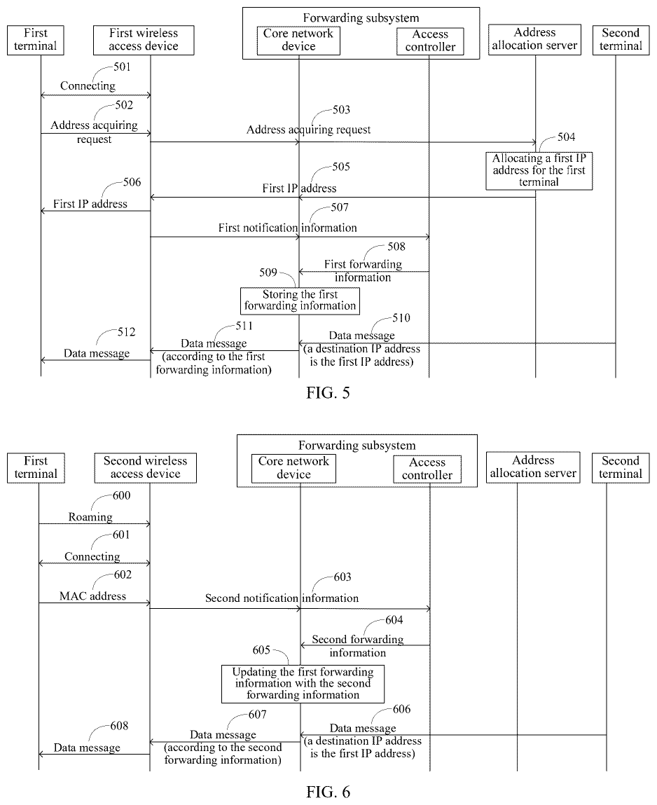

Furthermore, if the first terminal roams to the coverage of the second wireless access device, at this time, a communication process of the first terminal can be completed in conjunction with an embodiment shown in FIG. 6.

FIG. 6 is a schematic interaction flowchart of a communication method provided by an embodiment of the present invention. As shown in FIG. 6, the method includes following steps.
600, the first terminal roams from the first wireless access device to the second wireless access device.
601, the first terminal is connected to the second wireless access device.
602, the second wireless access device acquires the MAC address of the first terminal.

During a process of establishing a communication connection with the second wireless access device, the second wireless access device will acquire the MAC address of the first terminal.
603, the second wireless access device sends second notification information including the MAC address of the first terminal and a third IP address of the second wireless access device to the access controller.

Like the aforementioned embodiments, the third IP address is an IP address of the second wireless access device corresponding to the second network, the second network refers to the communication network between the wireless access device and the core network device.
604, the access controller in the forwarding subsystem sends, to the core network device in the forwarding subsystem, second forwarding information which is used for an indication of sending, to the second wireless access device, a data message for which a destination IP address is the first IP address.

As described in aforementioned embodiments, the MAC address of the first terminal is included in the first notification information received by the access controller, in this way, the access controller can locally store a corresponding relationship between the MAC address of the first terminal and the first IP address. Based on the corresponding relationship, when the access controller receives the above-mentioned second notification information, the access controller can determine, according to the MAC address of the first terminal, the first IP address of the first terminal. The second notification information is sent by the second wireless access device, which means that the first terminal has accessed the second wireless access device currently, therefore, the access controller issues a new forwarding rule to the core network device: an indication of sending, to the second wireless access device, the data message for which the destination IP address is the first IP address.
605, the core network device in the forwarding subsystem updates the first forwarding information with the second forwarding information.
606, the core network device in the forwarding subsystem receives the data message, sent by the second terminal, for which the destination IP address is the first IP address.
607, the core network device in the forwarding subsystem sends, according to the second forwarding information, the data message to the second wireless access device.
608, the second wireless access device sends the data message to the first terminal.

It should be noted that, the first network and the second network in the above-mentioned embodiments can both be one of wireless local area networks, mobile cellular networks, etc., or they can be any other network over which communication connections between different devices can be achieved.

For ease of understanding, the following provides a detailed explanation of a communication system according to an embodiment of the present invention by taking an example where the first network is a wireless local area network and the second network is a mobile cellular network.

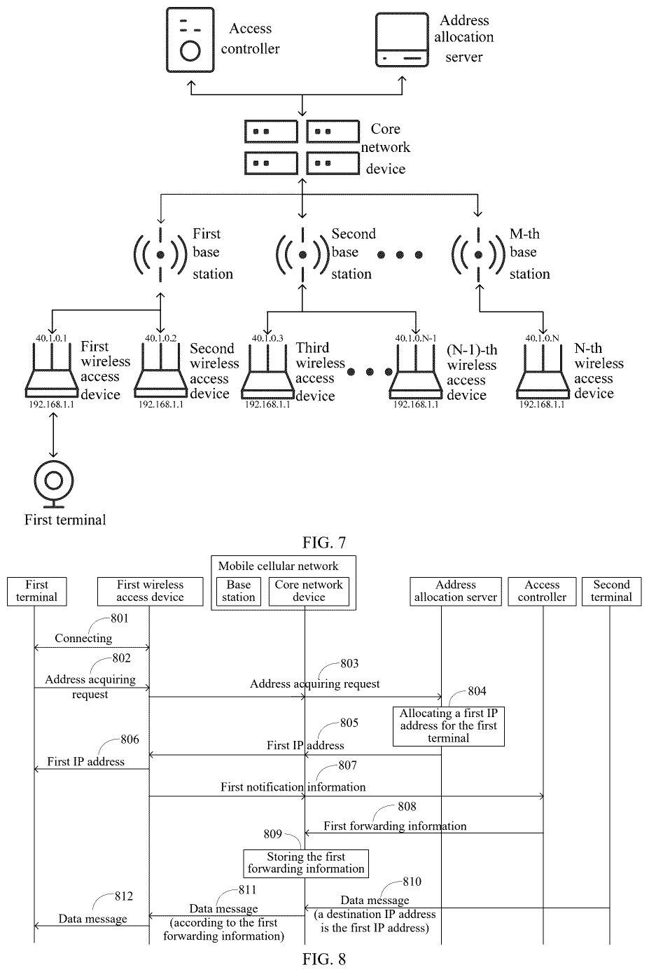

FIG. 7 is a schematic diagram of a communication system provided by an embodiment of the present invention, as shown in FIG. 7, it is assumed that the communication system includes multiple terminals (only a first terminal is shown in the drawing) which require network connection through a wireless local area network, N (N≥2) wireless access devices providing a wireless local area networking function and a mobile cellular networking function, a mobile cellular network formed by M (M≥1) base stations and a core network device, an access controller, and an address allocation server.

The access controller and the address allocation server are connected in communication with the core network device. The core network device is connected in communication with the base station(s). The base station(s) can establish, according to its/their own network coverage, a communication connection with a wireless access device within its/their own network coverage(s) in advance. A terminal can establish a communication connection with different wireless access devices as its location shifts, for example, the first terminal establishes a communication connection with a first wireless access device within a network coverage of the first wireless access device; when the first terminal moves to a network coverage of a second wireless access device, the first terminal can disconnect the communication connection with the first wireless access device and establish a communication connection with the second wireless access device.

The access controller may be an AC capable of achieving data configuration and management for the wireless access device(s). The address allocation server can include a DHCP (dynamic host configuration) server, etc. The core network device may be a cloud server formed by multiple core network elements contained therein. The base station can be a base station in a 5G network, or a base station in a 4G network, such as a gNB in the 5G network, or an eNB in the 4G network.

A wireless access device can be a CPE that can achieve mutual conversion between mobile cellular network signals and wireless local area network signals, for example, a 5G CPE, etc. Taking the wireless access device being a 5G CPE as an example, the 5G CPE can achieve mutual conversion between 5G signals and wireless local area network signals. In an embodiment of the present invention, the wireless access device (such as CPE) is integrated with an AP function, so that the above-mentioned N wireless access devices and the AC configured to control the wireless access devices can form a wireless local area network, a terminal in the wireless local area network can achieve network connection by accessing a wireless access device in the wireless local area network. Since the wireless local area network can perform data transmission by using a WiFi (Wireless Fidelity) protocol, it can also be referred to as a WiFi network.

It should be noted that, the access controller and the address allocation server can be deployed independent from the core network device, or can be deployed on the core network device in a form of software.

For ease of description, the wireless local area network will be referred to as the WiFi network in the following text, a terminal as mentioned above that requires network connection through the wireless local area network will be referred to as a WiFi terminal, and the above-mentioned mobile cellular network being a 5G network is taken as an example, with terminals therein referred to as 5G terminals.

In a practical application, the above-mentioned 5G network formed by the multiple base stations and the core network device can be a proprietary network (i.e., private network) of a target user. The target user does not refer to an individual user, but refer to an enterprise user, such as a certain company or institution. In this private network, there will be a large number of interconnection and interoperability scenarios between devices within the private network and devices within the private network, as well as between devices within the private network and devices in an external network. For example, there will be a need for communications between a 5G terminal within the private network and a WiFi terminal within the WiFi network.

Based on the communication system shown in FIG. 7 provided by the embodiment of the present invention, the WiFi network composed of ACs and APs (wireless access devices with AP function) can be integrated with the 5G network composed of the core network device and the base stations, and the Ethernet transmission between the ACs and the APs can be replaced by the 5G network, thereby expanding the coverage of the wireless local area network and better solving the interconnection and interoperability between 5G terminals and WiFi terminals in private networks.

In the communication system provided in the embodiment of the present invention, some constituent units therein should be relatively configured in advance, in order to ensure an implementation of smooth communication. Among them, mainly respective wireless access devices require to be configured.

Specifically, firstly, in a WiFi network, terminal devices therein corresponding to respective wireless access devices should be indistinguishable, therefore, it is necessary to configure the respective wireless access devices to have a same network name, that is, the SSIDs are the same. Secondly, in this WiFi network, all wireless access devices serve as a same gateway for the terminals, so the respective wireless access devices should also have the same IP address in the WiFi network, so that a terminal does not perceive any changes when roaming within a range of a different wireless access device. For example, as shown in FIG. 7, the respective wireless access devices each have an IP address of 192.168.1.1 in the WiFi network.

In addition, as mentioned above, the wireless access devices have communication functions of the WiFi network and the 5G network. In the WiFi network, in order to ensure that the respective wireless access devices function as a unified gateway for terminals, the respective wireless access devices have the same IP address in the WiFi network. However, in the 5G network, each wireless access device is a different communication entity for respective base stations. Therefore, in the 5G network, each wireless access device has a different IP address, such as 40.1.0.1, 40.1.0.2, . . . , 40.1.0.N shown in FIG. 7.

Based on this, it can be seen that each wireless access device actually is provided with two communication chips, respectively corresponding to the WiFi network and the 5G network, where each communication chip is configured with an IP address as mentioned above.

Based on the communication system shown in FIG. 7, for the first terminal acting as any WiFi terminal, assuming that it is currently connected to the first wireless access device, at this time, in order to meet the communication needs of the first terminal, the working process of respective constituent units in the communication system can be summarized as follows.

The first wireless access device is configured to: acquire, after being connected with the first terminal, a first IP address allocated for the first terminal by the address allocation server; and send first notification information to the access controller through the mobile cellular network, where the first notification information includes a second IP address of the first wireless access device and the first IP address, the second IP address is an IP address corresponding to the first wireless access device in the mobile cellular network, and the first IP address remains unchanged when the first terminal accesses a different wireless access device.

The access controller is configured to: receive the first notification information; and send first forwarding information to the core network device according to the first notification information, where the first forwarding information is used for an indication of sending, to the first wireless access device corresponding to the second IP address, a data message for which a destination IP address is the first IP address.

The core network device is configured to store the first forwarding information; and if upon reception of the data message, sent by the second terminal, for which the destination IP address is the first IP address, send the data message to the first wireless access device according to the first forwarding information, to enable the first wireless access device to send the data message to the first terminal.

For ease of understanding the working process of the above-mentioned respective constituent units, detailed explanation is made below in conjunction with following embodiments.

FIG. 8 is a schematic interaction flowchart of a communication method provided by an embodiment of the present invention. As shown in FIG. 8, the method includes following steps.
801, the first terminal is connected to the first wireless access device.
802, the first terminal sends an address acquiring request to the first wireless access device.

In this embodiment, it is assumed that the first terminal is first associated with the first wireless access device (such as a CPE), that is, a WiFi connection is established with the first wireless access device.

During a process of establishing a WiFi connection with the first wireless access device, based on the existing WiFi connection establishment process, the first wireless access device will acquire the MAC address of the first terminal.

After the first terminal establishes the WiFi connection with the first wireless access device, if the first terminal finds that it does not have an IP address of the WiFi network or a previously allocated IP address has expired, the first terminal will send the address acquiring request for requesting an IP address to the first wireless access device.
803, the first wireless access device sends the address acquiring request to the address allocation server through the mobile cellular network.

A respective wireless access device is configured with a relay forwarding function of the address acquiring request, this function enables the wireless access device to forward the received address acquiring request finally to the address allocation server, such as a DHCP server. Therefore, after receiving the address acquiring request sent by the first terminal, the first wireless access device forwards the address acquiring request to the base station accessed in, and this base station forwards the address acquiring request to the core network device, then the core network device forwards the address acquiring request to the address allocation server.
804, the address allocation server allocates the first IP address for the first terminal.
805, the address allocation server sends the first IP address to the first wireless access device through the mobile cellular network.
806, the first wireless access device sends the first IP address to the first terminal.
807, the first wireless access device sends first notification information including a second IP address corresponding to the first wireless access device in the mobile cellular network and the first IP address to the access controller through the mobile cellular network.

After receiving the first IP address allocated for the first terminal by the address allocation server, the first wireless access device, on the one hand, sends the first IP address to the first terminal, so that the first terminal is configured to subsequently use the first IP address for data transmission; and on the other hand, sends the first IP address of the first terminal and the second IP address of its own corresponding to the mobile cellular network to the access controller.

In fact, the above-mentioned first notification information may further include the MAC address of the first terminal.

In an embodiment of the present invention, all the IP addresses of the WiFi terminal are uniformly allocated by the address allocation server, and if the validity period of the IP address is not considered, it can be assumed that the IP address (referring to an IP address used for communication within the wireless local area network and allocated by the address allocation server) of the same terminal remains unchanged when accessing different wireless access devices.
808, the access controller sends, to the core network device, first forwarding information which is used for an indication of sending, to the first wireless access device, a data message for which a destination IP address is the first IP address.
809, the core network device stores the first forwarding information.

After receiving the above-mentioned first notification information, the access controller learns that the first terminal has accessed the first wireless access device currently, and then issues a forwarding rule to the core network deice, that is, the first forwarding information which is used for an indication of sending, to the first wireless access device, a data message for which a destination IP address is the first IP address.

In a practical application, the core network device can open an API for external calls to write forwarding rules, and the access controller can call the API to write the first forwarding information to the core network device.
810, the core network device receives the data message, sent by the second terminal, for which the destination IP address is the first IP address.
811, the core network device sends the data message to the first wireless access device according to the first forwarding information.

The second terminal may be a 5G terminal connected in communication with a certain base station in the mobile cellular network. When the second terminal needs to send the data message to the first terminal, the data message will carry the first IP address of the first terminal therein, the data message is firstly sent to a base station currently accessed by the second terminal, and then is forwarded by the base station to the core network device, the core network device needs to query in a local forwarding table for forwarding information matched for the data message after receiving the data message. The forwarding table stores several pieces of forwarding information. The core network device queries in the forwarding table based on the destination IP address (i.e., the first IP address) in the data message; and if the first forwarding information for which the destination IP address is the first IP address is queried, sends, according to description in the first forwarding information, the data message to the first wireless access device corresponding to the second IP address.
812, the first wireless access device sends the data message to the first terminal.

In summary, in the solution provided by this embodiment, all IP addresses of respective WiFi terminals are uniformly allocated by the address allocation server, so that an IP address of a WiFi terminal remains unchanged when it roams among different wireless access devices, so that the services for communication and transmission in progress on the WiFi terminal will not experience service interruptions due to IP address changes caused by the WiFi terminal roaming among different wireless access devices. Moreover, by integrating into the mobile cellular network between the access controller and the wireless access devices, the coverage of the wireless local area network formed by the access controller and the wireless access devices is expanded.

In a practical application, the first terminal may experience a shift in location, it may roam from the first wireless access device to which the first terminal is originally connected to coverage of the second wireless access as its location shifts. Assuming that the first terminal roams to the coverage of the second wireless access, at this time, a communication process of the first terminal can be completed in conjunction with an embodiment shown in FIG. 3.

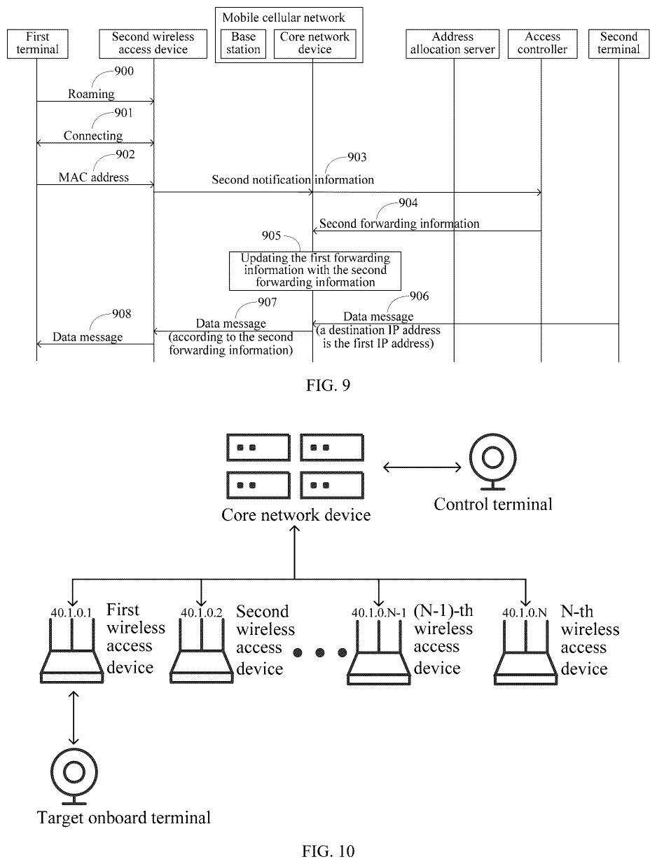

FIG. 9 is a schematic interaction flowchart of a communication method provided by an embodiment of the present invention. As shown in FIG. 9, the method includes following steps.
900, the first terminal roams from the first wireless access device to the second wireless access device.
901, the first terminal is connected to the second wireless access device.
902, the second wireless access device acquires the MAC address of the first terminal.

During a process of establishing a WiFi connection with the second wireless access device, based on the existing WiFi connection establishment process, the second wireless access device will acquire the MAC address of the first terminal.
903, the second wireless access device sends, through the mobile cellular network, second notification information including the MAC address of the first terminal and a corresponding third IP address of the second wireless access device in the mobile cellular network to the access controller.
904, the access controller sends, to the core network device, second forwarding information which is used for an indication of sending, to the second wireless access device, a data message for which a destination IP address is the first IP address.

As described in aforementioned embodiments, the first notification information received by the access controller includes the MAC address of the first terminal, in this way, the access controller can locally store a corresponding relationship between the MAC address of the first terminal and the first IP address. Based on the corresponding relationship, when the access controller receives the above-mentioned second notification information, the access controller can determine the first IP address of the first terminal. The second notification information is sent by the second wireless access device, which means that the first terminal has accessed the second wireless access device currently, therefore, the access controller issues a new forwarding rule to the core network device: an indication of sending, to the second wireless access device, the data message for which the destination IP address is the first IP address.
905, the core network device updates the first forwarding information with the second forwarding information.
906, the core network device receives the data message, sent by the second terminal, for which the destination IP address is the first IP address.
907, the core network device sends the data message to the second wireless access device according to the second forwarding information.
908, the second wireless access device sends the data message to the first terminal.

It can be known, from the above-mentioned solution, that when the first terminal roams among different wireless access devices, its IP address will not change, and services will not be interrupted. Moreover, based on the roaming situation of the first terminal among different wireless access devices, a corresponding forwarding rule in the core network device can be updated in real time, with simple implementations and low costs.

In a practical application, the above-mentioned communication system can be configured as a proprietary communication network system for a target user. The target user may include a department or group such as an enterprise, a school, hospital, etc. An example is taken where the target user is an automobile enterprise, this enterprise can configure the above-mentioned communication system as a vehicle-to-everything communication system, and control, test and other operations on the vehicle can be implemented through the vehicle-to-everything communication system.

The communication method of the terminal device provided by an embodiment of the present invention can also be suitable for the vehicle-to-everything communication system, the vehicle-to-everything communication system may be a proprietary network of a certain enterprise, or definitely can be a public network.

FIG. 10 is a schematic diagram of a vehicle-to-everything communication system provided by an embodiment of the present invention. As shown in FIG. 10, assuming there are multiple (assumed to be N) wireless access devices and multiple vehicles with autonomous driving functions deployed in the vehicle-to-everything communication system, each vehicle is equipped with multiple onboard terminals for collecting vehicular driving data (only a target onboard terminal is illustrated in the drawing). For example, the onboard terminal can receive vehicular driving environment information collected by an onboard camera and various vehicular driving status (such as position, speed, etc.) information collected by a speed sensor and other devices. The wireless access devices are, for example, CPEs.

In an embodiment, the vehicle-to-everything communication system can be a proprietary network for an automobile enterprise user, and the above-mentioned plurality of wireless access devices can be deployed in an experimental park of the automobile enterprise user. In this case, the above-mentioned multiple vehicles can be vehicles used for conducting autonomous driving function tests. A scenario where the automobile enterprise user tests autonomous driving functions of vehicles in the experimental park is used as an example, in order to test autonomous driving functions of a vehicle, the experimental park can also be deployed with infrastructure for simulating real roads, such as highways, traffic signals, zebra crossings, lane markings, green belts, etc.

In addition, the vehicle-to-everything communication system also has a core network device deployed therein, the plurality of wireless access devices and the core network device are connected in communication. In a practical application, the vehicle-to-everything communication system also has a control terminal (which may be a server or a server cluster) deployed therein, the control terminal may access the above-mentioned core network device to remotely control the onboard terminals in the park.

It should be noted that the configuration information of the wireless access devices in this embodiment is the same as the configuration information of the wireless access devices in the communication system shown in FIG. 1, which will not be repeated here.

Based on the vehicle-to-everything communication system shown in FIG. 10, assuming that the first terminal is currently connected to the first wireless access device, at this time, in order to meet the requirements for communication between the first terminal and the second terminal, the working process of respective constituent units in the communication system can be summarized as follows.

The first wireless access device is configured to: acquire, after being connected with an onboard terminal, a first IP address allocated by the core network device for the onboard terminal; and send the first notification information to the core network device, where the first notification information includes a second IP address of the first wireless access device and the first IP address.

The core network device is configured to: generate first forwarding information according to the first notification information, where the first forwarding information is used for an indication of sending, to the first wireless access device corresponding to the second IP address, a data message for which a destination IP address is the first IP address; and, if upon reception of the data message, sent by the control terminal, for which the destination IP address is the first IP address, send the data message to the first wireless access device according to the first forwarding information, to enable the first wireless access device to send the data message to the onboard terminal.

In a practical application, in an implementation, the core network device may include a core network element, an IP address allocation element, and a wireless controller element configured to control the plurality of wireless access devices (assuming they are CPEs, only a first wireless access device CPE1 and a second wireless access device CPE2 are shown in the drawing). Among them, the IP address allocation element, the wireless controller element and a base station are respectively connected to the core network element. The wireless controller element is configured to manage the plurality of wireless access devices, the IP address allocation element is configured to allocate a communication address for an onboard terminal.

In a scenario of a proprietary network for automobile enterprise users, a wireless local area network for the automobile enterprise users is formed by the above-mentioned multiple CPEs and the wireless controller element, and an onboard terminal can achieve network connection by being connected with the CPE. In a scenario of a public network, multiple CPEs still provide access function for an onboard terminal, and the onboard terminal can achieve network connection by being connected with the CPE.

For ease of understanding the working process of the above-mentioned respective constituent units, detailed explanation is made below in conjunction with following embodiments.

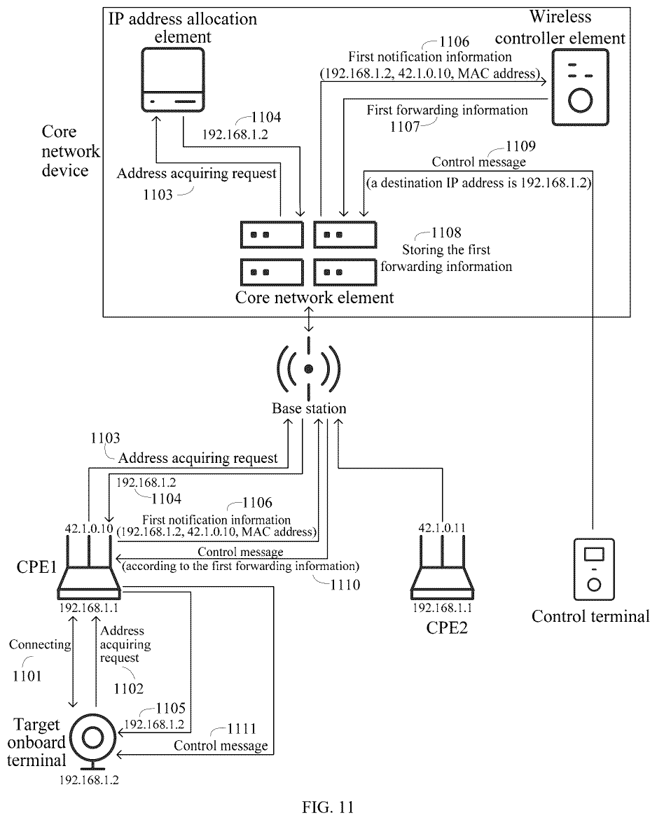

In the above-mentioned communication system, taking a target onboard terminal deployed on a certain vehicle as an example, the control terminal needs to send a control message to the target onboard terminal to control the working status of the target onboard terminal, such as acceleration, deceleration, steering, etc., of the vehicle. In order to achieve the transmission of the control message between the control terminal and the target onboard terminal, the working process of the respective constituent units in the above-mentioned vehicle-to-everything communication system is shown in FIG. 11.
1101, the target onboard terminal is connected to the CPE1.

In this embodiment, the target onboard terminal is first associated with the CPE1, that is, a WiFi connection is established with the CPE1. During a process of the target onboard terminal establishing a WiFi connection with the CPE1, based on the existing WiFi connection establishment process, the CPE1 will acquire the MAC address of the target onboard terminal. In this embodiment, it is assumed that an IP address corresponding to the CPE1 in the mobile cellular network is 42.1.0.10.
1102, the target onboard terminal sends an address acquiring request to the CPE1.

In this embodiment, after the target onboard terminal establishes the WiFi connection with the CPE1, if the target onboard terminal finds that it does not have an IP address of the WiFi network or a previously allocated IP address has expired, the target onboard terminal will send the address acquiring request for requesting an IP address to the CPE1.
1103, the CPE1 sends the address acquiring request to the IP address allocation element in the core network device.

In this embodiment, each CPE is configured with a relay forwarding function of the address acquiring request, this function enables the CPE1 to forward the received address acquiring request finally to the IP address allocation element in the core network device. Therefore, after receiving the address acquiring request sent by the target onboard terminal, the CPE1 forwards the address acquiring request to a base station accessed in, and this base station forwards the address acquiring request to the core network element in the core network device, then the core network element forwards the address acquiring request to the IP address allocation element.
1104, the IP address allocation element in the core network device allocates an IP address of 192.168.1.2 for the target onboard terminal, and then sends the IP address of 192.168.1.2 to the CPE1.

In this embodiment, the IP address of 192.168.1.2 allocated for the target onboard terminal by the IP address allocation element in the core network device is an IP address of the target onboard terminal in the WiFi network.
1105, the CPE 1 sends the IP address of 192.168.1.2 to the target onboard terminal.
1106, the CPE1 sends first notification information including 192.168.1.2, 42.1.0.10 and the MAC address of the target onboard terminal to the wireless controller element in the core network device.
1107, the wireless controller element in the core network device sends, to the core network element in the core network device, first forwarding information which is used for an indication of sending, to the CPE1, a control message for which a destination IP address is 192.168.1.2.
1108, the core network element in the core network device stores the first forwarding information.
1109, the core network element in the core network device receives the control message, sent by the control terminal, for which the destination IP address is 192.168.1.2.
1110, the core network element in the core network device sends the control message to the CPE1 according to the first forwarding information.
1111, the CPE1 sends the control message to the target onboard terminal.

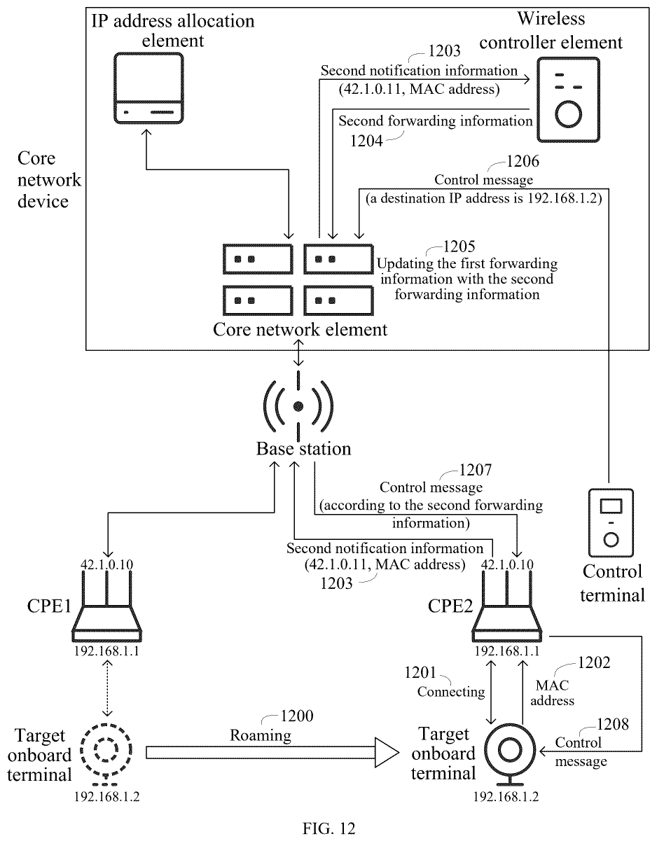

In a practical application, the target onboard terminal may experience a shift in location as the vehicle travels, and as its location shifts, the target onboard terminal may roam from the CPE1 to which it is originally connected to coverage of the CPE2. Assuming that the target onboard terminal roams to the coverage of the CPE2, in the above-mentioned situation, the working process of the respective constituent units in the communication system within the experimental park is shown in FIG. 12.
1200, the target onboard terminal roams from the CPE1 to the CPE2.

In this embodiment, it is assumed that a third IP address corresponding to the CPE2 in the mobile cellular network is 42.1.0.11.
1201, the target onboard terminal is connected to the CPE2.
1202, the CPE2 acquires a MAC address of the target onboard terminal.

In this embodiment, during a process of the target onboard terminal establishing a WiFi connection with the CPE2, based on the existing WiFi connection establishment process, the CPE2 will acquire the MAC address of the target onboard terminal.
1203, the CPE2 sends second notification information including the MAC address of the target onboard terminal and the third IP address of 42.1.0.11 to the wireless controller element in the core network device.
1204, the wireless controller element in the core network device sends, to the core network element in the core network device, second forwarding information which is used for an indication of sending, to the CPE2, a control message for which a destination IP address is 192.168.1.2.

As described in the embodiments shown in FIG. 11, the first notification information received by the wireless controller element includes the MAC address of the target onboard terminal, in this way, the wireless controller element can locally store a corresponding relationship between the MAC address of the target onboard terminal and 192.168.1.2. Based on the corresponding relationship, when the wireless controller element receives the above-mentioned second notification information, the wireless controller element can determine that the IP address of the target onboard terminal is 192.168.1.2. The second notification information is sent by the CPE2, which means that the target onboard terminal has accessed the CPE2 currently, therefore, the wireless controller element issues a new forwarding rule to the core network element: an indication of sending, to the CPE2, the control message for which the destination IP address is 192.168.1.2.
1205, the core network element in the core network device updates the first forwarding information with the second forwarding information.
1206, the core network element in the core network device receives the control message, sent by the control terminal, for which the destination IP address is 192.168.1.2.
1207, the core network element in the core network device sends the control message to the CPE2 according to the second forwarding information.
1208, the CPE2 sends the control message to the target onboard terminal.

It should be noted that, in an implementation, the CPE1 and the CPE2 in FIG. 11 and FIG. 12 have the same IP address in the wireless local area network. In the above embodiments, the CPE1 and the CPE2 have the same IP address of 192.168.1.1 in the wireless local area network, and correspondingly, the SSIDs of the CPE1 and the CPE2 are also the same.

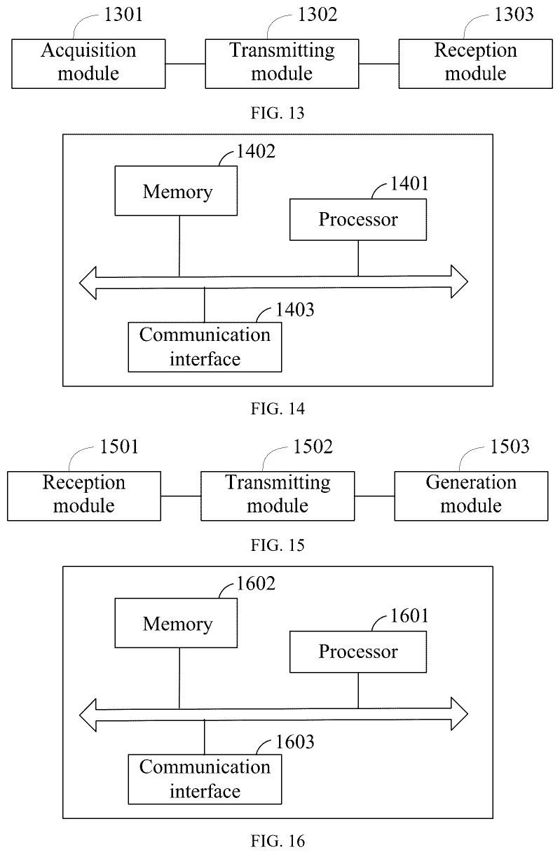

FIG. 13 is a schematic structure diagram of a communication apparatus provided by an embodiment of the present invention. As shown in FIG. 13, the apparatus is arranged in any target wireless access device in a plurality of wireless access devices contained within a communication system, where the communication system includes: a first terminal, a second terminal, the plurality of wireless access devices, and a core network device connected in communication with the plurality of wireless access devices; the apparatus includes an acquisition module 1301, a transmitting module 1302 and a reception module 1303.

The acquisition module 1301 is configured to acquire, after being connected with the first terminal, a first IP address allocated for the first terminal by the core network device.

The transmitting module 1302 is configured to send first notification information including a second IP address of the target wireless access device of a first IP address to the core network device, to enable the core network device to generate forwarding information according to the first notification information, where the forwarding information is used for an indication of sending, to the target wireless access device corresponding to the second IP address, a data message for which a destination IP address is the first IP address.

The reception module 1303 is configured to receive the data message, forwarded by the core network device, for which the destination IP address is the first IP address; where the core network device sends the data message to the target wireless access device according to the forwarding information when the data message sent by the second terminal is received;

The transmitting module 1302 is further configured to send the data message to the first terminal.

In an embodiment, the acquisition module 1301 is further configured to: acquire a MAC address of the first terminal during a process of establishing a connection with the first terminal, and carry the MAC address in the first notification information to notify the core network device; in response to that the first terminal is roamed from another wireless access device to coverage of the target wireless access device, acquire the MAC address of the first terminal during a process of establishing a connection with the first terminal. Correspondingly, the transmitting module 1302 is further configured to send, to the core network device, second notification information including a second IP address of the target wireless access device and the MAC address, to enable the core network device to determine the first IP address corresponding to the MAC address, and generate the forwarding information.

The communication apparatus shown in FIG. 13 can perform various steps executed by the communication system in the aforementioned embodiments. For the parts not described in detail in this embodiment, please refer to the relevant explanations of the aforementioned embodiments, which will not be repeated here.

In a possible design, the structure of the above-mentioned communication apparatus shown in FIG. 13 can be implemented as a wireless access device. As shown in FIG. 14, the wireless access device can include: a processor 1401, a memory 1402, and a communication interface 1403. The memory 1402 stores executable codes thereon, and when the executable codes are executed by the processor 1401, the processor 1401 is enabled to at least implement the communication method according to the aforementioned embodiments.

FIG. 15 is a schematic structure diagram of a communication apparatus provided by an embodiment of the present invention. As shown in FIG. 15, the apparatus is arranged in a core network device contained within a communication system, where the communication system includes: a first terminal, a second terminal, a plurality of wireless access devices, and the core network device connected in communication with the plurality of wireless access devices; the apparatus includes a reception module 1501, a transmitting module 1502 and a generation module 1503.

The reception module 1501 is configured to receive an address acquiring request sent by a first wireless access device in the plurality of wireless access devices, where the address acquiring request is sent to the first wireless access device after the first terminal is connected to the first wireless access device.

The transmitting module 1502 is configured to send a first IP address allocated for the first terminal to the first wireless access device, to enable the first wireless access device to send the first IP address to the first terminal.

The reception module 1501 is further configured to receive first notification information sent by the first wireless access device, where the first notification information includes a second IP address of the first wireless access device and the first IP address of the first terminal.

The generation module 1503 is configured to: generate first forwarding information according to the first notification information, where the first forwarding information is used for an indication of sending, to the first wireless access device corresponding to the second IP address, a data message for which a destination IP address is the first IP address.

The transmitting module 1502 is further configured to: if upon reception of the data message, sent by the second terminal, for which the destination IP address is the first IP address, send the data message to the first wireless access device according to the first forwarding information, to enable the first wireless access device to send the data message to the first terminal.

In an embodiment, the first notification information includes a MAC address of the first terminal, where the MAC address is obtained by the first wireless access device during establishment of a connection with the first terminal.

Correspondingly, the reception module 1501 is further configured to: receive second notification information sent by a second wireless access device in the plurality of wireless access devices, the second notification information including a third IP address of the second wireless access device and the MAC address, where the second wireless access device acquires the MAC address during establishment of a connection with the first terminal; determine, according to the second notification information, the first IP address corresponding to the MAC address. The generation module 1503 is further configured to generate second forwarding information, where the second forwarding information is used for an indication of sending, to the second wireless access device corresponding to the third IP address, the data message for which the destination IP address is the first IP address.

The communication apparatus shown in FIG. 15 can perform various steps executed by the communication system in the aforementioned embodiments. For the parts not described in detail in this embodiment, please refer to the relevant explanations of the aforementioned embodiments, which will not be repeated here.

In a possible design, the structure of the above-mentioned communication apparatus shown in FIG. 15 can be implemented as a core network device. As shown in FIG. 16, the core network device can include: a processor 1601, a memory 1602, and a communication interface 1603. The memory 1602 stores executable codes thereon, and when the executable codes are executed by the processor 1601, the processor 1601 is enabled to at least implement the communication method according to the aforementioned embodiments.

In addition, an embodiment of the present invention provide a non-transitory machine-readable storage medium, where the non-transitory machine-readable storage medium stores executable codes thereon. When the executable codes are executed by a processor of an electronic device, the processor is enabled to at least implement the communication method executed by the communication system in the aforementioned embodiments.

The above-described embodiments of the apparatus are only illustrative, and the network elements described as separate components may or may not be physically separated. Some or all of the modules therein can be selected according to actual needs to achieve the purpose of the solutions of the embodiments. Those of ordinary skill in the art can understand and implement without any creative effort.

According to the description of the above implementations, those of ordinary skill in the art can clearly understand that each implementation can be implemented by adding necessary universal hardware platforms, or of course, by combining hardware and software. Based on this understanding, the above-mentioned technical solutions can essentially or part of the technical solutions contributing to the existing technology can be reflected in the form of a computer product. The present invention can be implemented in the form of a computer program product implemented on one or more computer usable storage media (including but not limited to disk storage, CD-ROM (Compact disc read-only memory), optical storage, etc.) containing computer usable program codes.

Finally, it should be noted that the above embodiments are only used to illustrate the technical solutions of the present invention, and not to limit it. Although the present invention has been described in detail with reference to the aforementioned embodiments, those of ordinary skill in the art should understand that they can still modify the technical solutions described in the aforementioned embodiments, or equivalently replace some of the technical features therein; and these modifications or substitutions do not cause the essence of corresponding technical solutions depart from the spirit and scope of the technical solutions of the respective embodiments of the present invention.

1. A communication system, comprising:
a first terminal, a second terminal, a plurality of wireless access devices, and a core network device connected in communication with the plurality of wireless access devices;
wherein a first wireless access device in the plurality of wireless access devices is configured to: acquire, after being connected with the first terminal, a first Internet protocol (IP) address allocated for the first terminal by the core network device; and send first notification information to the core network device, wherein the first notification information comprises a second IP address of the first wireless access device and the first IP address;
the core network device is configured to: generate first forwarding information according to the first notification information, wherein the first forwarding information is used for an indication of sending, to the first wireless access device corresponding to the second IP address, a data message for which a destination IP address is the first IP address; and, if upon reception of the data message, sent by the second terminal, for which the destination IP address is the first IP address, send the data message to the first wireless access device according to the first forwarding information, to enable the first wireless access device to send the data message to the first terminal.

2. The system according to claim 1, wherein the core network device is provided with a core network element, an IP address allocation element, and a wireless controller element configured to control the plurality of wireless access devices;
wherein the first IP address is allocated by the IP address allocation element;
wherein the first notification information is sent to the wireless controller element, the first forwarding information is generated by the wireless controller element and sent to the core network element;
wherein the core network element receives the data message, and sends the data message to the first wireless access device according to the first forwarding information.

3. The system according to claim 1, wherein the first terminal is configured to send, after being connected with the first wireless access device, an address acquiring request to the first wireless access device, and receive the first IP address fed back from the first wireless access device;
the first wireless access device is configured to forward the address acquiring request to the core network device, receive the first IP address allocated for the first terminal by the core network device, and send the first IP address to the first terminal.

4. The system according to claim 1, wherein the first wireless access device is further configured to obtain a media access control (MAC) address of the first terminal during a process of establishing a connection with the first terminal, and carry the MAC address in the first notification information to notify the core network device;
the first terminal is configured to be connected with a second wireless access device in the plurality of wireless access devices when roaming to coverage of the second wireless access device;
the second wireless access device is configured to: acquire the MAC address during a process of establishing a connection with the first terminal; and send second notification information to the core network device, wherein the second notification information comprises a third IP address of the second wireless access device and the MAC address;
the core network device is configured to: determine, according to the second notification information, the first IP address corresponding to the MAC address, generate second forwarding information which is used for an indication of sending, to the second wireless access device corresponding to the third IP address, the data message for which the destination IP address is the first IP address, and update the first forwarding information to the second forwarding information; and, if upon reception of the data message, sent by the second terminal, for which the destination IP address is the first IP address, send the data message to the second wireless access device according to the second forwarding information, to enable the second wireless access device to send the data message to the first terminal.

5. A communication method, applied to any target wireless access device in a plurality of wireless access devices contained within a communication system, wherein the communication system comprises: a first terminal, a second terminal, the plurality of wireless access devices, and a core network device connected in communication with the plurality of wireless access devices; the method comprises:
acquiring, after being connected with the first terminal, a first Internet protocol (IP) address allocated for the first terminal by the core network device;
sending first notification information comprising a second IP address of the target wireless access device and the first IP address to the core network device, to enable the core network device to generate forwarding information according to the first notification information, wherein the forwarding information is used for an indication of sending, to the target wireless access device corresponding to the second IP address, a data message for which a destination IP address is the first IP address;
receiving the data message, forwarded by the core network device, for which the destination IP address is the first IP address; wherein the core network device sends the data message to the target wireless access device according to the forwarding information when the data message sent by the second terminal is received; and
sending the data message to the first terminal.

6. The method according to claim 5, further comprising:
obtaining a media access control (MAC) address of the first terminal during a process of establishing a connection with the first terminal, and carrying the MAC address in the first notification information to notify the core network device;
in response to that the first terminal is roamed from another wireless access device to coverage of the target wireless access device, acquiring the MAC address of the first terminal during the process of establishing a connection with the first terminal; and
sending, to the core network device, second notification information comprising the second IP address of the target wireless access device and the MAC address, to enable the core network device to determine the first IP address corresponding to the MAC address and generate the forwarding information.

7. A communication method, applied to a core network device contained within a communication system, wherein the communication system comprises: a first terminal, a second terminal, a plurality of wireless access devices, and the core network device connected in communication with the plurality of wireless access devices; the method comprises:
receiving an address acquiring request sent by a first wireless access device in the plurality of wireless access devices, wherein the address acquiring request is sent to the first wireless access device after the first terminal is connected with the first wireless access device;
sending a first Internet protocol (IP) address allocated for the first terminal to the first wireless access device, to enable the first wireless access device to send the first IP address to the first terminal;
receiving first notification information sent by the first wireless access device, wherein the first notification information comprises the first IP address of the first terminal and a second IP address of the first wireless access device;
generating first forwarding information according to the first notification information, wherein the first forwarding information is used for an indication of sending, to the first wireless access device corresponding to the second IP address, a data message for which a destination IP address is the first IP address; and
if upon reception of the data message, sent by the second terminal, for which the destination IP address is the first IP address, sending the data message to the first wireless access device according to the first forwarding information, to enable the first wireless access device to send the data message to the first terminal.

8. The method according to claim 7, wherein the first notification information comprises a media access control (MAC) address of the first terminal, the MAC address is obtained by the first wireless access device during a process of establishing a connection with the first terminal;
the method further comprises:
receiving second notification information sent by a second wireless access device in the plurality of wireless access devices, the second notification information comprising a third IP address of the second wireless access device and the MAC address, wherein the second wireless access device acquires the MAC address during a process of establishing a connection with the first terminal;
determining, according to the second notification information, the first IP address corresponding to the MAC address; and
generating second forwarding information, wherein the second forwarding information is used for an indication of sending, to the second wireless access device corresponding to the third IP address, the data message for which the destination IP address is the first IP address.

9. A wireless access device, comprising: a memory, a processor, and a communication interface; wherein the memory stores executable codes thereon, and when the executable codes are executed by the processor, the processor is enabled to perform the communication method according to claim 5.

10. A core network device, comprising: a memory, a processor, and a communication interface; wherein the memory stores executable codes thereon, and when the executable codes are executed by the processor, the processor is enabled to perform the communication method according to claim 7.

11.-15. (canceled)

16. The system according to claim 4, wherein the core network device is provided with a core network element and a wireless controller element configured to control the plurality of wireless access devices;
wherein the second notification information is sent to the wireless controller element, the second forwarding information is generated by the wireless controller element and sent to the core network element;
wherein the first forwarding information is updated to the second forwarding information by the core network element, the data message is received by the core network element, the data message is sent, by the core network element, to the second wireless access device according to the second forwarding information.

17. The system according to claim 2, wherein the core network element is specifically configured to:
after receiving the data message, query in a local forwarding table for forwarding information matched for the data message based on the first IP address in the data message, wherein the forwarding table stores several pieces of forwarding information;
if the first forwarding information for which the destination IP address is the first IP address is queried, send, according to description in the first forwarding information, the data message to the first wireless access device.

18. The method according to claim 5, wherein the acquiring, after being connected with the first terminal, a first IP address allocated for the first terminal by the core network device comprises:
receiving, after being connected with the first terminal, the address acquiring request sent by the first terminal;
forwarding the address acquiring request to the core network device; and
receiving the first IP address, sent by the core network device, allocated for the first terminal by the core network device.

19. The method according to claim 7, wherein the core network device is provided with a core network element, an IP address allocation element, and a wireless controller element configured to control the plurality of wireless access devices;
the receiving an address acquiring request sent by a first wireless access device in the plurality of wireless access devices comprises: receiving, by the IP address allocation element, the address acquiring request sent by the first wireless access device in the plurality of wireless access devices;
the sending a first IP address allocated for the first terminal to the first wireless access device comprises: sending, by the core network element, the first IP address allocated for the first terminal to the first wireless access device;
the receiving first notification information sent by the first wireless access device comprises: receiving, by the wireless controller element, the first notification information sent by the first wireless access device;
the generating first forwarding information according to the first notification information comprises: generating, by the wireless controller element, the first forwarding information according to the first notification information, and sending, by the wireless controller element, the first forwarding information to the core network element;
the if upon reception of the data message, sent by the second terminal, for which the destination IP address is the first IP address, sending the data message to the first wireless access device according to the first forwarding information comprises: if the data message sent by the second terminal is received by the core network element, sending, by the core network element, the data message to the first wireless access device according to the first forwarding information.

20. The method according to claim 7, wherein the if upon reception of the data message, sent by the second terminal, for which the destination IP address is the first IP address, sending the data message to the first wireless access device according to the first forwarding information comprises:
after receiving the data message, query in a local forwarding table for forwarding information matched for the data message based on the first IP address in the data message, wherein the forwarding table stores several pieces of forwarding information;
if the first forwarding information for which the destination IP address is the first IP address is queried, send, according to description in the first forwarding information, the data message to the first wireless access device.
